(19) United States
(12) Patent Application Publication
(10) Pub. No.: US 2008/0000587 A1
(43) Pub. Date: Jan. 3, 2008

(54) Bonding apparatus of semiconductor package

(76) Inventors: Yong-dae Ha, Asan-si (KR); Cheal-sang Yoon, Cheon-si (KR); Jeong-soon Cho, Cheonan-si (KR); Bum-woo Lee, Asan-si (KR); Young-gon Hwang, Cheonan-si (KR); Mok-kun Kwon, Asan-si (KR)

Correspondence Address: LEE & MORSE, P.C., 3141 FAIRVIEW PARK DRIVE, SUITE 500, FALLS CHURCH, VA, 22042, US

(21) Appl. No.: 11/710,521

(22) Filed: Feb. 26, 2007

(30) Foreign Application Priority Data
Jun. 28, 2006 (KR) 10-2006-0058884

(51) Int. Cl. B29C 65/00

(52) U.S. Cl. 156/378

(57) ABSTRACT

A bonding apparatus for a semiconductor package determines whether a bottom of a bonding head is contaminated, and may include a contamination detecting unit for a bonding head attached to a body to apply pressure to the semiconductor package. The contamination detecting unit is below the bonding head to detect contamination on the bottom of the bonding head, a bonding block, and a bonding stage.

### BACKGROUND OF THE INVENTION

1. Field of the Invention

The present invention relates to a fabrication apparatus of a semiconductor package, and more particularly, to a bonding apparatus of a semiconductor package that is capable of detecting contamination of a bonding head.

2. Description of the Related Art

The fabrication of a semiconductor package may include a bonding process whereby a die may be bonded to a lead frame and the like, i.e., a die bonding process. That is, the die bonding process may bond a die, which is individually separated from a wafer, to a die pad of a lead frame having an adhesive material, e.g., an epoxy. The system that may perform the bonding process is a die bonding apparatus.

The die bonding apparatus may include a bonding stage where the die and the lead frame may be securely seated, and a bonding head to apply pressure to the die. The die, which may be placed on the lead frame with an adhesive material, may be placed on the bonding stage. The die may then be pressed by the bonding head so as to be bonded to the lead frame. The procedure may be continuously repeated to bond each die.

The bottom of the bonding head may be contaminated during the die bonding process by the adhesive material of the lead frame, e.g., epoxy, adhesive tape, or the like. Furthermore, pieces of broken wafers may be bonded to the bottom of the bonding head. When the bottom of the bonding head is contaminated, applied pressure to the die may become non-uniform, and thus may damage the die.

### SUMMARY OF THE INVENTION

The present invention is therefore directed to a bonding apparatus of a semiconductor package, which substantially overcomes one or more of the problems due to limitations and disadvantages of the related art.

It is therefore a feature of an embodiment of the present invention to provide a bonding apparatus for a semiconductor package that is capable of determining whether a bonding head is contaminated.

It is therefore another feature of an embodiment of the present invention to provide a bonding apparatus for a semiconductor package that is capable of determining whether a bonding stage is contaminated.

According to an aspect of the present invention, there is provided a bonding apparatus for a semiconductor package comprising a body, a bonding head attached to the body for applying pressure to a semiconductor package, and a detecting unit disposed below the bonding head for detecting contaminant material on the bonding head.

In other embodiments, a second detecting unit may be disposed below the bonding head to detect contaminant material on a bonding stage.

In other embodiments, the detecting unit may include a light source emitting light, a cover to house the light source, the cover including an aperture through which the light from the light source passes toward the bonding head, and a light-receiving unit receiving the light reflected from the bonding head.

In other embodiments, a mirror may be disposed inside the cover to direct the light reflected from the bonding head toward the light-receiving unit.

In still other embodiments, the light-receiving unit may be a charge-coupled device.

In still other embodiments, the bonding stage may be disposed outside a set of rails for transferring the semiconductor package.

In yet other embodiments, the detecting unit may be disposed outside the rails.

In still other embodiments, the bonding stage may be disposed inside a set of rails to support the semiconductor package.

In yet other embodiments, the detecting unit may be disposed inside the rails.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1A illustrates a partially cut-away perspective view of a bonding apparatus for a semiconductor package including a detector, according to an embodiment of the present invention;

FIG. 1B illustrates a cross-sectional view of the bonding apparatus for a semiconductor package illustrated in FIG. 1A;

FIG. 2A illustrates a plan view of the bonding apparatus for a semiconductor package illustrated in FIG. 1A;

FIG. 2B illustrates a front view of the bonding apparatus for a semiconductor package illustrated in FIG. 2A;

FIG. 2C illustrates a side view of the bonding apparatus for a semiconductor package illustrated in FIG. 2A;

FIG. 3A illustrates a plan view illustrating a bonding apparatus for a semiconductor package according to another embodiment of the present invention; and

FIG. 3B illustrates a side view of the bonding apparatus for a semiconductor package illustrated in FIG. 3A.

### DETAILED DESCRIPTION OF THE INVENTION

Korean Patent Application No. 10-2006-0058884, filed on Jun. 28, 2006, in the Korean Intellectual Property Office, and entitled: “Bonding Apparatus of Semiconductor Package,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

Embodiments of the present invention provide a detector checking whether the bottom of a bonding head in a bonding apparatus of a semiconductor package is contaminated or not. The detector may be formed in various shapes, and the present invention provides the optimum embodiment. For convenience of explanation, the embodiments of the present invention are classified depending on the position of the detector. However, the present invention is not limited to the embodiments described below.

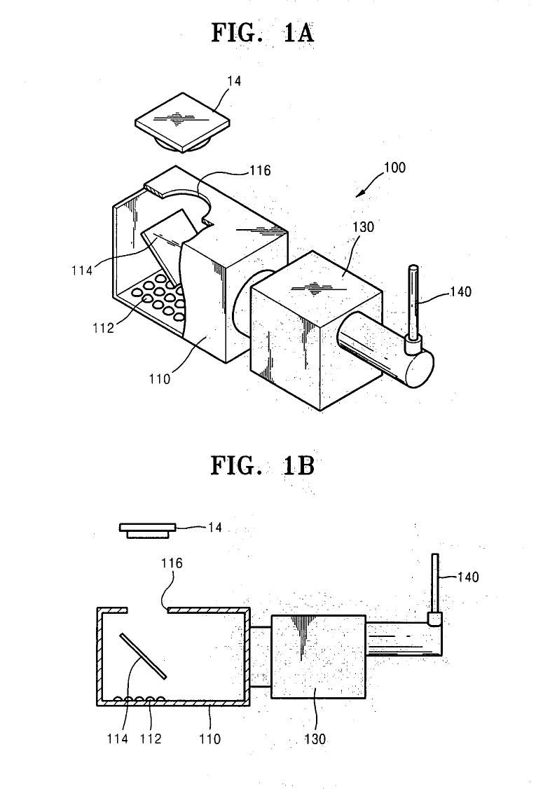

FIG. 1A illustrates a partially cut-away perspective view of a bonding apparatus for a semiconductor package including a detecting unit 100 according to an embodiment of the present invention, and FIG. 1B illustrates a cross-sectional view of the bonding apparatus for a semiconductor package illustrated in FIG. 1A. A part of cover 110 is removed for convenience of explanation.

Referring to FIGS. 1A and 1B, a light source 112 for providing light may be disposed on the bottom of the cover 110 in the detecting unit 100 of an embodiment of the present invention. The cover 110 may include an aperture 116 through which the light from the light source 112 may pass en route to the bottom of a bonding head 14. The light source 112 may be provided in various shapes and types according to need, e.g., the intensity of illumination of the bottom of the bonding head 14. The diameter of the aperture 116 may be large enough so that the light from the light source completely illuminates the bottom of the bonding head 14. The shape of the aperture 116 may be varied to match the shape of the bottom of the bonding head 14, e.g., when the bottom of the bonding head 14 has a circular shape, the shape of the aperture 116 may also have a circular shape.

A mirror 114 may be disposed above the light source 112 so that any light reflected from the bottom of the bonding head 14 may be directed to a light-receiving unit 130. The mirror 114 may be disposed diagonally inside the cover 110. The size of the mirror 114 may be large enough so that it may receive any light reflected from the bottom of the bonding head 14. The mirror 114 may have optical characteristics whereby it may transmit light from the light source 112 to the bonding head 14, and may reflect any light reflected from the bottom of the bonding head 14 to the light receiving unit 130. That is, the kind and size of the mirror 114 may be determined with respect to the position of the light source 112.

In order to receive the light reflected from the mirror 114, the light-receiving unit 130 may be disposed adjacent to one side of the cover 110. The light-receiving unit 130 may use a charge-coupled device (CCD) capable of converting the received light into an electrical signal. The electrical signal may be transferred to an external control unit or a display unit (not shown) by a signal-processing line 140.

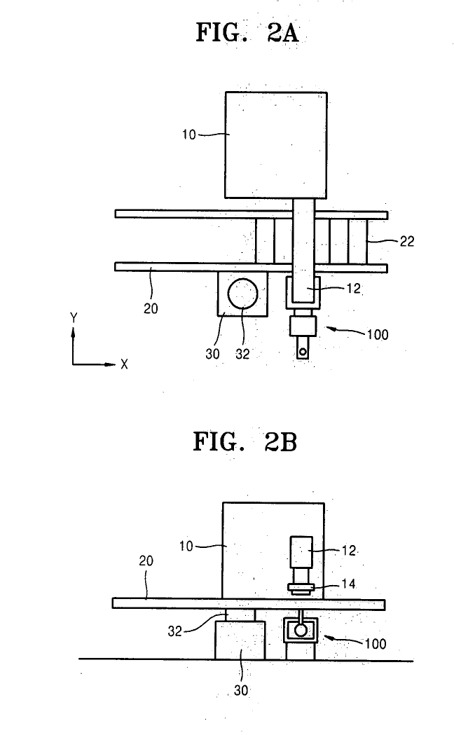

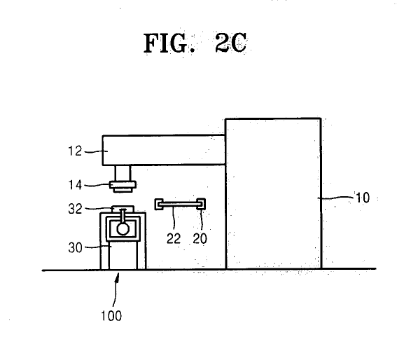

FIG. 2A illustrates a plan view of the bonding apparatus for a semiconductor package illustrated in FIG. 1A, FIG. 2B illustrates a front view of the bonding apparatus for a semiconductor package illustrated in FIG. 2A, and FIG. 2C illustrates a side view of the bonding apparatus for a semiconductor package illustrated in FIG. 2A.

Referring to FIGS. 2A-2C, the bonding apparatus of the present invention may include the bonding head 14, rails 20, a bonding stage 32, and a detecting unit 100. The bonding head 14 may move up and down by means of a bonding arm 12 connected to a body 10. The bonding head 14 may apply pressure to a lead frame 22. If necessary, heat may also be applied to the bonding head 14 along with pressure. The bottom of the bonding head 14 may have a flat shape to enable the bonding head 14 to apply uniform pressure to the upper surface of a flat die (not shown) placed on the lead frame 22. Although not shown in the drawing, the lead frame and its die may be transferred to the bonding stage 32 using a separate transfer mechanism.

The rails 20 may supply the lead frame 22 to the bonding stage periodically, and may be driven so as to move in one direction. The bonding stage 32 may have a die placed thereon by the lead frame 22 by, e.g., vacuum, and may be disposed on a table 30 that may be rotatable and capable of moving along an x-axis and a y-axis. In another embodiment, another detecting unit (not shown) may be further disposed below the bonding head 14 in order to detect contaminant materials on the bonding stage 32 where the lead frame 22 may be seated, or on a bonding block (not shown).

The detecting unit 100 may be disposed below the bonding head 14, and may detect whether the bottom of the bonding head 14 is contaminated. The detecting unit 100 may be the same as the detecting unit 100 explained in reference to FIGS. 1A-1B, above. According to an embodiment of the present invention illustrated in FIGS. 2A-2C, the bonding stage 32 may be disposed at a position outside the rails 20 used for transferring the lead frame, and thus, the detecting unit 100 may be also disposed outside the rails 20.

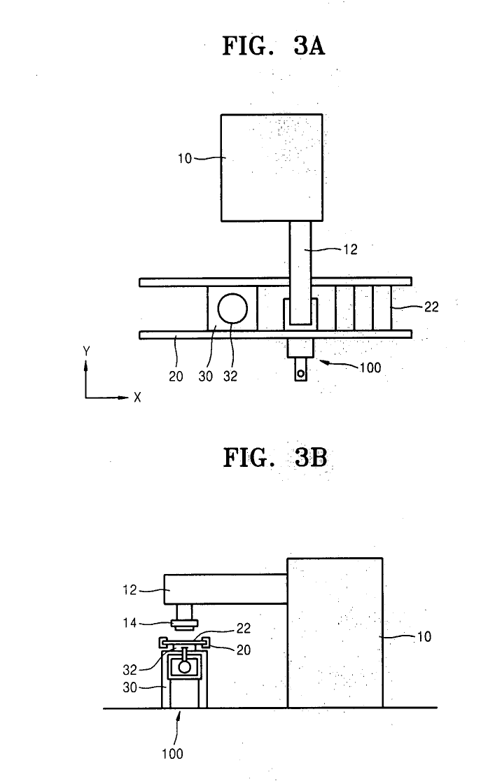

FIG. 3A illustrates a plan view of a bonding apparatus for a semiconductor package according to an embodiment of the present invention, and FIG. 3B illustrates a side view of the bonding apparatus for a semiconductor package illustrated in FIG. 3A. The embodiment of FIGS. 3A-3B may be the same as the embodiment explained in reference to FIGS. 2A-2C except for the positions of the bonding stage 32 and the detecting unit 100.

Referring to FIGS. 3A-3B, the detecting unit 100 may be disposed below the bonding head 14 and may detect whether the bottom of the bonding head 14 is contaminated. The detecting unit 100 may be the same as the detecting unit 100 explained in reference to FIGS. 1A-1B. In the embodiment of FIGS. 3A-3B, the bonding stage 32 may be disposed inside the rails 20 used for transferring a lead frame 22. Thus, the detecting unit 100 may also be disposed inside the rails 20.

The embodiments shown in FIGS. 1-3 illustrate that the detecting unit 100 of the present invention may be disposed in various positions. The bonding apparatus of a semiconductor package, according to embodiments of the present invention, may include a detecting unit 100 capable of detecting contamination on the bottom of a bonding head 14. Such detection capability may thereby prevent a die from being damaged due to the application of non-uniform pressure from a contaminated bonding head 14.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A bonding apparatus for a semiconductor package comprising:
a body;
a bonding head on the body for applying pressure to the semiconductor package; and
a detecting unit beneath the bonding head for detecting contaminant material on the bonding head.

2. The bonding apparatus for a semiconductor package as claimed in claim 1, further comprising a second detecting unit beneath the bonding head for detecting contaminant material on a bonding stage.

3. The bonding apparatus for a semiconductor package as claimed in claim 1, wherein the detecting unit comprises:
a light source emitting light;
a cover to house the light source, the cover including an aperture through which the light from the light source passes toward the bonding head; and
a light-receiving unit receiving light reflected from the bonding head.

4. The bonding apparatus for a semiconductor package as claimed in claim 3, further comprising a mirror on the inside of the cover to direct the light reflected from the bonding head toward the light-receiving unit.

5. The bonding apparatus for a semiconductor package as claimed in claim 3, wherein the light-receiving unit is a charge-coupled device (CCD).

6. The bonding apparatus for a semiconductor package as claimed in claim 2, wherein the bonding stage is disposed outside a set of rails for transferring the semiconductor package.

7. The bonding apparatus for a semiconductor package as claimed in claim 6, wherein the detecting unit is disposed outside the set of rails.

8. The bonding apparatus for a semiconductor package as claimed in claim 2, wherein the bonding stage is disposed inside a set of rails to support the semiconductor package.

9. The bonding apparatus for a semiconductor package as claimed in claim 8, wherein the detecting unit is disposed inside the set of rails.
